(19) United States
(12) Patent Application Publication
(10) Pub. No.: US 2024/0413506 A1
(43) Pub. Date: Dec. 12, 2024

(54) BATTERY

(71) Applicant: TOYOTA JIDOSHA KABUSHIKI KAISHA, Toyota-shi (JP)

(72) Inventors: Takeru HARA, Toyota-shi (JP); Takuya MURATA, Kariya-shi (JP)

(73) Assignee: TOYOTA JIDOSHA KABUSHIKI KAISHA, Toyota-shi (JP)

(21) Appl. No.: 18/735,975

(22) Filed: Jun. 6, 2024

(30) Foreign Application Priority Data
Jun. 9, 2023 (JP) 2023-095884

(51) Int. Cl. H01M 50/627; H01M 4/13; H01M 10/0525; H01M 10/0585; H01M 10/42; H01M 50/103

(52) U.S. Cl. CPC H01M 50/627; H01M 4/13; H01M 10/0525; H01M 10/0585; H01M 10/4235; H01M 50/103

(57) ABSTRACT

A battery has an stack of electrodes including collectors and active material layers that are divided and between which grooves are provided; a sealing body forming, between the collectors, internal spaces in which electrolytic liquid is accommodated, and sealing the internal spaces; and injection ports in the sealing body and communicating the internal spaces and an exterior. The internal spaces are formed by the grooves and, at peripheries of the active material layers, uncoated regions at which the active material layers are not provided. An internal region sealed by the sealing body is a polygonal shape when viewed from a stacking direction of the electrode stack. The grooves extend from an injection port side in a direction opposite thereto, between the active material layers. At least grooves A and B having different widths are provided as the grooves, and groove A width is wider than groove B width.

### CROSS-REFERENCE TO RELATED APPLICATION

This application is based on and claims priority under 35 USC 119 from Japanese Patent Application No. 2023-095884 filed on Jun. 9, 2023, the disclosure of which is incorporated by reference herein.

### BACKGROUND

### Technical Field

The present disclosure relates to a battery.

### Related Art

A manufacturing method including a step of injecting an electrolytic liquid into a space between electrodes that are disposed so as to face one another with a separator therebetween, is known as a conventional method of manufacturing a battery (see, for example, Japanese Patent Application Laid-Open (JP-A) No. 2013-191450).

Further, JP-A No. 2022-188536 discloses a method of manufacturing a bipolar power storage device, including: a first pressure-reducing step of reducing the pressure of an internal space of a battery to a first pressure at a time of causing an electrolytic liquid to permeate into the internal space; a first injecting step of injecting a predetermined amount of an electrolytic liquid from a retaining portion, which retains a predetermined amount of the electrolytic liquid set in advance, through an injection port into the internal space whose pressure was reduced in the first pressure-reducing step; a second pressure-reducing step of, through the retaining portion and the injection port, reducing the pressure of the internal space, into which the predetermined amount of the electrolytic liquid was injected, to a second pressure, and causing some of the electrolytic liquid to flow backward from the internal space into the retaining portion; and a second injecting step of making the interior of the retaining portion, which retains the electrolytic liquid that flowed backward, be a pressure that is higher than the second pressure, and injecting the electrolytic liquid from the retaining portion through the injection port into the internal space. The second pressure-reducing step includes an initial pressure-reducing step of reducing the pressure of the internal space at a pressure-reducing speed that is lower than that in the first pressure-reducing step.

### SUMMARY

Reducing the volume (the width) of an uncoated region, at which an active material layer is not formed on a collector, has been studied in conventional batteries from the standpoint of improving the battery capacity. However, if the width of the uncoated region is made to be too small, there is the problem that the ability of the electrolytic liquid to circulate through the grooves that are formed in the active material layer deteriorates.

The present disclosure was made in view of the above-described circumstances, and an object thereof is to provide a battery in which the ability of an electrolytic liquid to permeate into an active material layer is improved.

Means for achieving the above-described object include the following aspects.

A battery of a first aspect of the present disclosure, including:
an electrode stack formed by stacking of electrodes that include collectors and active material layers, which are provided on one or both surfaces of the collectors and between which plural grooves are provided and which are divided into plural regions;
a sealing body that forms, between the collectors that are adjacent to one another, internal spaces in which an electrolytic liquid is accommodated, and that seals the internal spaces; and
injection ports formed in the sealing body and communicating the internal spaces and an exterior,
wherein
the internal spaces are formed by the grooves and by, at peripheries of the active material layers, uncoated regions at which the active material layers are not provided,
an internal region sealed by the sealing body is a polygonal shape when viewed from a stacking direction of the electrode stack, and
given that a surface of the sealing body, which surface is at the internal space side and is at a side in which the injection ports are formed, is an injection port side surface,
the grooves extend from a side of the injection port side surface in a direction opposite the injection port side surface, between the active material layers, and
at least a groove A and a groove B that have different widths are provided as the plural grooves, and a width of the groove A is wider than a width of the groove B.

The battery of a second aspect according to the present disclosure is the battery of the first aspect, wherein
the internal region sealed by the sealing body is a quadrangular shape when viewed from the stacking direction of the electrode stack, and
the injection ports are provided in the sealing body only at a region facing one side of the quadrangular shape.

The battery of a third aspect according to the present disclosure is the battery of the first aspect or the second aspect, wherein at least one of the grooves A satisfies at least one condition among following (A1) and (A2).

(A1) Among the plural grooves, the groove A is provided at a position closest to the injection port.

(A2) The groove A is provided at a position nearest to a position that is equidistant from a groove, which is provided furthest toward an end, and from a groove, which is provided at an end at an opposite side, in a direction in which the plural grooves are lined-up.

The battery of a fourth aspect according to the present disclosure is the battery of any one of the first aspect to the third aspect, wherein ratio ([d_{B}]/[d_{A}]) of width [d_{B}] of the groove B with respect to width [d_{A}] of the groove A is greater than or equal to 0.07 and less than or equal to 0.40.

The battery of a fifth aspect according to the present disclosure is the battery of any one of the first aspect to the fourth aspect, wherein width [d_{B}] of the groove B is greater than or equal to 0.5 mm and less than or equal to 4.0 mm.

In accordance with the present disclosure, there is provided a battery in which the ability of an electrolytic liquid to permeate into an active material layer is improved.

### BRIEF DESCRIPTION OF THE DRAWINGS

FIG. 1 is a schematic sectional view illustrating the structure of a bipolar storage device relating to an embodiment;

FIG. 2 is a schematic sectional view illustrating the internal structure of a power storing module illustrated in FIG. 1; and

FIG. 3 is a cross-sectional view orthogonal to the stacking direction of the power storing module illustrated in FIG. 2.

### DETAILED DESCRIPTION

A battery relating to an embodiment of the present disclosure is described hereinafter with reference to the drawings. In the explanation of the drawings, the same reference numerals are used for elements that are the same or equivalent, and redundant description is omitted.

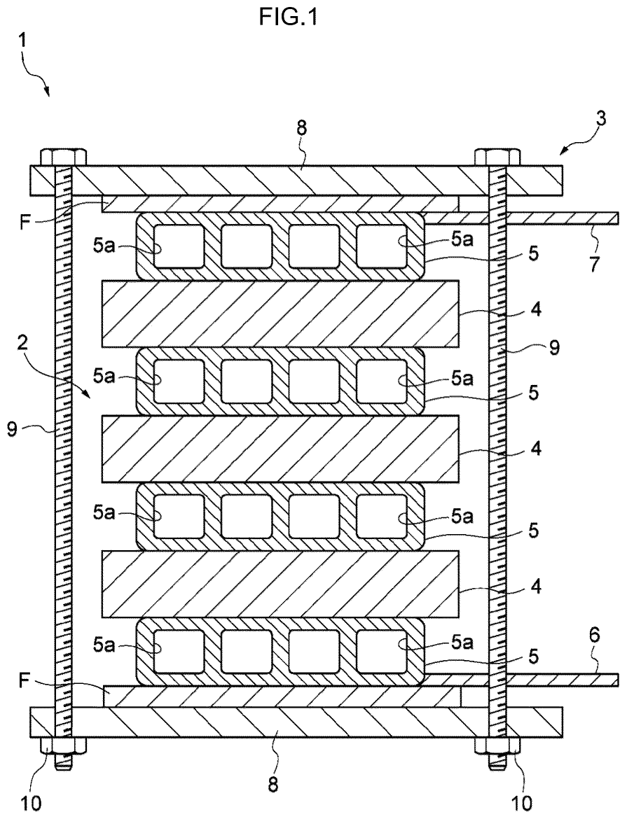

FIG. 1 is a schematic sectional view illustrating the structure of a bipolar power storage device relating to an embodiment. Bipolar power storage device 1 (also simply called “power storage device 1” hereinafter) illustrated in FIG. 1 is a device used in batteries of various types of vehicles such as, for example, forklifts, hybrid vehicles, electric vehicles and the like. The power storage device 1 is a secondary battery such as, for example, a nickel-hydrogen secondary battery, a lithium ion secondary battery, or the like. A case in which the power storage device 1 is a lithium ion secondary battery is exemplified in the present embodiment. The power storage device 1 has a module stack 2, and a restraining member 3 applying a restraining load to the module stack 2 in the stacking direction of the module stack 2.

The module stack 2 has power storing modules 4, and conductive plates 5 disposed so as to be stacked on the power storing modules 4. The module stack 2 includes the plural (here, three) power storing modules 4 and the plural (here, four) conductive plates 5. The power storing module 4 is a bipolar battery, and is rectangular as seen from the stacking direction.

The power storing modules 4 that are disposed adjacent to one another in the stacking direction are electrically connected to one another via the conductive plates 5. The conductive plates 5 are disposed between the power storing modules 4 that are adjacent to one another in the stacking direction, and at the outer sides of the power storing modules 4 that are positioned at the ends of the stack. A positive electrode terminal 6 is connected to one of the conductive plates 5 that is disposed at the outer side of the power storing module 4 positioned at an end of the stack. A negative electrode terminal 7 is connected to the other of the conductive plates 5 that is disposed at the outer side of the power storing module 4 positioned at an end of the stack. The positive electrode terminal 6 and the negative electrode terminal 7 are drawn out from edges of the conductive plates 5 for example, in a direction intersecting the stacking direction. Charging/discharging of the power storage device 1 are carried out by the positive electrode terminal 6 and the negative electrode terminal 7.

Plural flow paths 5a, through which a coolant such as air or the like flows, are provided at the interiors of the conductive plates 5. The flow paths 5a extend, for example, along a direction intersecting (orthogonal to) both the stacking direction and the direction in which the positive electrode terminal 6 and the negative electrode terminal 7 are drawn out. The conductive plates 5 have both the function of connecting members that electrically connect the power storing modules 4 to one another, and the function of heat dissipating plates that dissipate the heat generated at the power storing modules 4 due to the coolant flowing through these flow paths 5a.

The restraining member 3 is structured by a pair of end plates 8 that sandwich the module stack 2 in the stacking direction, and fastening bolts 9 and nuts 10 that fasten the end plates 8 together. Films F that are electrically insulating are provided at the surfaces, which are at the module stack 2 sides, of the end plates 8, and the end plates 8 and the conductive plates 5 are insulated by the films F.

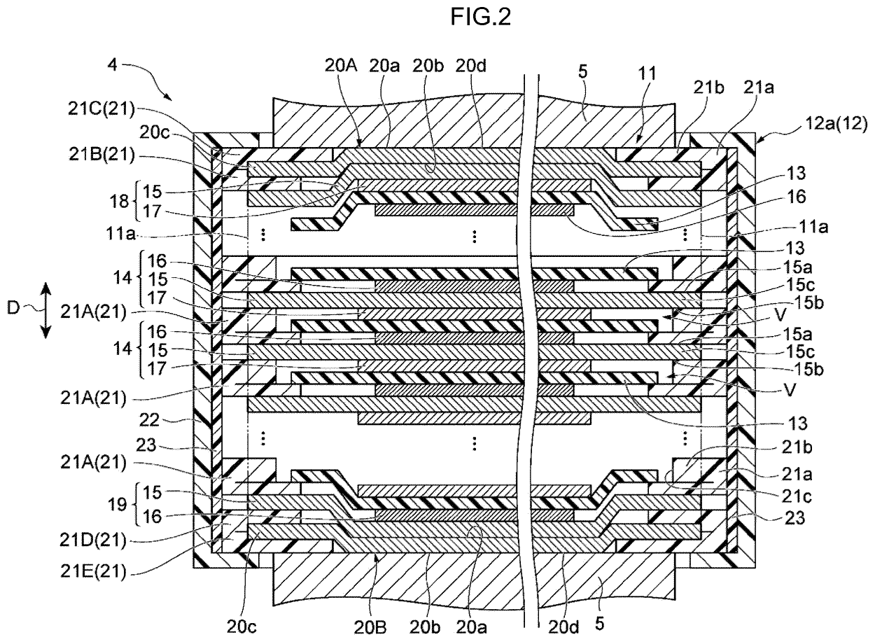

The structure of the power storing module 4 is described in detail next. FIG. 2 is a schematic sectional view illustrating the internal structure of the power storing module illustrated in FIG. 1. As illustrated in FIG. 2, the power storing module 4 has an electrode stack 11, and a scaling body 12 made of resin and sealing the electrode stack 11. The power storing module 4 is formed in a rectangular parallelopiped shape for example.

The electrode stack 11 includes plural electrodes that are stacked along stacking direction D via separators 13, and collectors (metal plates 20A, 20B) positioned at the stack ends of the electrode stack 11. The plural electrodes include negative electrode final end electrode 18, positive electrode final end electrode 19, and plural bipolar electrodes 14 stacked between the negative electrode final end electrode 18 and the positive electrode final end electrode 19. The stack of the plural bipolar electrodes 14 is provided between the negative electrode final end electrode 18 and the positive electrode final end electrode 19.

The bipolar electrode 14 has a metal plate 15 serving as a collector and including one surface 15a and another surface 15b provided at the side opposite the one surface 15a, a positive electrode 16 provided on the one surface 15a, and a negative electrode 17 provided on the another surface 15b. The one surface 15a is a surface facing one way in the stacking direction D, and, for example, faces upward in the gravitational direction. The another surface 15b is a surface facing the other way in the stacking direction D, and, for example, faces downward in the gravitational direction. The positive electrode 16 is a positive electrode active material layer formed by a positive electrode active material being coated on the metal plate 15. The negative electrode 17 is a negative electrode active material layer formed by a negative electrode active material being coated on the metal plate 15. At the electrode stack 11, the positive electrode 16 of one bipolar electrode 14 faces, via the separator 13, the negative electrode 17 of another bipolar electrode 14 that is adjacent thereto at one side in the stacking direction D. At the electrode stack 11, the negative electrode 17 of one bipolar electrode 14 faces, via the separator 13, the positive electrode 16 of another bipolar electrode 14 that is adjacent thereto at another side in the stacking direction D.

The negative electrode final end electrode 18 has the metal plate 15, and the negative electrode 17 that is provided at the another surface 15b of the metal plate 15. The negative electrode final end electrode 18 is disposed at one end side in the stacking direction D such that the another surface 15b faces the central side in the stacking direction D at the electrode stack 11. The metal plate 20A is further stacked on the one surface 15a of the metal plate 15 of the negative electrode final end electrode 18, and the negative electrode final end electrode 18 is electrically connected to the one conductive plate 5, which is adjacent to the power storing module 4, via this metal plate 20A. The negative electrode 17, which is provided at the another surface 15b of the metal plate 15 of the negative electrode final end electrode 18, faces, via the separator 13, the positive electrode 16 of the bipolar electrode 14 that is at one end in the stacking direction D.

The positive electrode final end electrode 19 has the metal plate 15, and the positive electrode 16 that is provided at the one surface 15a of the metal plate 15. The positive electrode final end electrode 19 is disposed at the another end side in the stacking direction D such that the one surface 15a faces the central side in the stacking direction D at the electrode stack 11. The metal plate 20B is further stacked on the another surface 15b of the metal plate 15 of the positive electrode final end electrode 19, and the positive electrode final end electrode 19 is electrically connected to the another conductive plate 5, which is adjacent to the power storing module 4, via this metal plate 20B. The positive electrode 16, which is provided at the one surface 15a of the metal plate 15 of the positive electrode final end electrode 19, faces, via the separator 13, the negative electrode 17 of the bipolar electrode 14 that is at the another end in the stacking direction D.

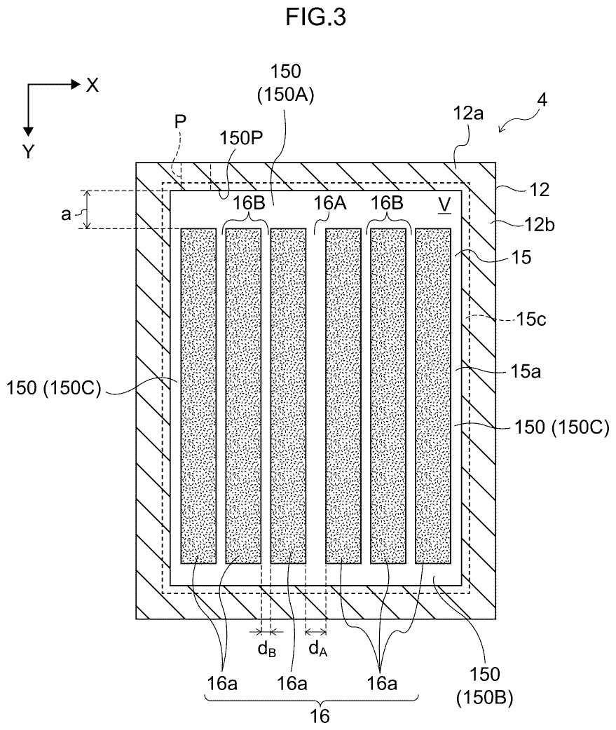

The metal plate 15 is formed from a metal such as, for example, Al, SUS, Ni, Cu or the like. Each of the metal plates 15 is one metal plate that is included in the electrode stack 11. Edge portions 15c of the metal plates 15 are rectangular frame shaped, and form portions of uncoated regions 15d (see FIG. 3) at which neither a positive electrode active material nor a negative electrode active material is coated. Examples of the positive electrode active material that structures the positive electrode 16 are oxide active materials. Examples of oxide active materials are layered rock salt type active materials such as LiCoO₂, LiMnO₂, LiNiO₂, LiVO₂, LiNi_{1/3}CO_{1/3}Mn_{1/3}O₂ and the like, spinel type active materials such as LiMn₂O₄, Li(Ni_{0.5}Mn_{1.5})O₄ and the like, and olivine type active materials such as LiFePO₄, LiMnPO₄, LiNiPO₄, LiCuPO₄ and the like. Examples of the negative electrode active material that structures the negative electrode 17 are carbon active materials, oxide active materials, and metal active materials. In the present embodiment, the formed region of the negative electrode 17 at the another surface 15b of the metal plate 15 is one size larger than the formed region of the positive electrode 16 at the one surface 15a of the metal plate 15. The electrode stack 11 has the plural metal plates 15, 20A, 20B that are stacked.

The separator 13 is a member for preventing short-circuiting between the metal plates 15, and is formed in the shape of a sheet for example. Examples of the separator 13 are porous films formed from polyolefin resins such as polyethylene (PE), polypropylene (PP) and the like, woven or non-woven fabrics formed from polypropylene, methyl cellulose or the like, and the like. The separators 13 may be reinforced by vinylidene fluoride resin compounds. Note that the separators 13 are not limited to being sheet-shaped, and may be bag-shaped.

The metal plates 20A, 20B are members that are substantially the same as the metal plates 15, and are formed from a metal such as, for example, Al, SUS, Ni, Cu or the like. The metal plates 20A, 20B are each one metal plate included in the electrode stack 11. The metal plates 20A, 20B form uncoated electrodes at which neither of a positive electrode active material layer nor a negative electrode active material layer is formed on one surface 20a and another surface 20b. Namely, the metal plates 20A, 20B are uncoated electrodes at which an active material layer is not provided on either surface thereof.

Due to the metal plate 20A, the negative electrode final end electrode 18 is in a state of being disposed between the metal plate 20A and the bipolar electrode 14 along the stacking direction D. The another surface 20b of the metal plate 20A and the one surface 15a of the metal plate 15 of the negative electrode final end electrode 18 are electrically connected by direct contact without anything interposed therebetween. Due to the metal plate 20B, the positive electrode final end electrode 19 is in a state of being disposed between the metal plate 20B and the bipolar electrode 14 along the stacking direction D. The one surface 20a of the metal plate 20B and the another surface 15b of the metal plate 15 of the positive electrode final end electrode 19 are electrically connected by direct contact without anything interposed therebetween.

At the electrode stack 11, the central region of the electrode stack 11 (the region where the active material layers are disposed at the bipolar electrodes 14, the negative electrode final end electrode 18 and the positive electrode final end electrode 19) bulges-out in the stacking direction D as compared with the region at the periphery thereof. Therefore, the metal plates 20A, 20B are bent in directions in which the central regions of the metal plates 20A, 20B move away from one another. The central regions of the one surface 20a of the metal plate 20A and the another surface 20b of the metal plate 20B contact the conductive plates 5.

The sealing body 12 is, overall, formed in the shape of a rectangular tube by an insulative resin for example. The sealing body 12 is, for example, formed in the shape of a rectangular tube that has a pair of short-side portions 12a and a pair of long-side portions 12b (see FIG. 3). The sealing body 12 is provided so as to surround side surfaces 11a of the electrode stack 11. The sealing body 12 holds the edge portions 15c at the side surfaces 11a.

The sealing body 12 has plural first sealing portions 21 (resin portions) that are frame-shaped and are respectively provided at the edge portions of the metal plates included in the electrode stack 11 (i.e., the edge portions 15c of the metal plates 15 and edge portions 20c of the metal plates 20A, 20B), and a second sealing portion 22 that surrounds the first sealing portions 21 from the outer sides and along the side surfaces 11a and that is joined to the first sealing portions 21 respectively. The first sealing portions 21 and the second sealing portion 22 are insulative resins for example, and examples of structural materials of the resins are polypropylene (PP), polyphenylene sulfide (PPS), modified polyphenylene ether (PPE) and the like.

The first scaling portions 21 are provided continuously over the entire peripheries of the edge portions 15c of the metal plates 15 and the edge portions 20c of the metal plates 20A, 20B, and are formed in the shapes of rectangular frames as seen from the stacking direction D. The first sealing portions 21 and the metal plates 15, and the first sealing portions 21 and the metal plates 20A, 20B, respectively, are joined airtightly. As seen from the stacking direction D, the first sealing portions 21 extend to further toward the outer sides than the edge portions 15c of the metal plates 15 and the edge portions 20c of the metal plates 20A, 20B. The first sealing portions 21 include outer side portions 21a that jut-out further toward the outer sides than the edges of the metal plates 15 and the metal plates 20A, 20B, and inner side portions 21b positioned further toward the inner sides than the edges of the metal plates 15 and the metal plates 20A, 20B. Welded layers 23 are formed at the distal end portions (the outer edge portions) of the outer side portions 21a of the first scaling portions 21.

The plural first sealing portions 21 include plural first sealing portions 21A provided at the bipolar electrodes 14 and the positive electrode final end electrode 19, a first sealing portion 21B provided at the negative electrode final end electrode 18, a first scaling portion 21C provided at the metal plate 20A, and first sealing portions 21D, 21E provided at the metal plate 20B.

The first sealing portions 21A are joined to the one surfaces 15a of the metal plates 15 of the bipolar electrodes 14 and the positive electrode final end electrode 19. The inner side portions 21b of the first sealing portions 21A are positioned between the edge portions 15c of the metal plates 15 that are adjacent to one another in the stacking direction D. The overlapping regions of the edge portions 15c at the one surfaces 15a of the metal plates 15 and the first sealing portions 21A are the joined regions of the metal plates 15 and the first scaling portions 21A.

In the present embodiment, the first sealing portion 21A is formed as a two-layer structure due to a single film being folded-over in two. The outer edge portions of the first sealing portions 21A that are embedded in the second sealing portion 22 are the folded-over portions (the bent portions) of the films. The film of the first layer that structures the first scaling portion 21A is joined to the one surface 15a. The inner edge of the film of the second layer is positioned further toward the outer side than the inner edge of the film of the first layer, and forms a step portion on which the separator 13 is placed. The inner edge of the film of the second layer is positioned further toward the inner side than the edge of the metal plate 15.

The first sealing portion 21B is joined to the one surface 15a of the metal plate 15 of the negative electrode final end electrode 18. The inner side portion 21b of the first scaling portion 21B is positioned between the edge portion 15c of the metal plate 15 of the negative electrode final end electrode 18, and the edge portion 20c of the metal plate 20A, which are adjacent to one another in the stacking direction D. The overlapping region of the edge portion 15c at the one surface 15a of the metal plate 15 and the inner side portion 21b of the first scaling portion 21B is the joined region of the metal plate 15 and the first sealing portion 21B. The first scaling portion 21B is joined also to the another surface 20b of the metal plate 20A. The overlapping region of the edge portion 20c at the another surface 20b of the metal plate 20A and the first sealing portion 21B is the joined region of the metal plate 20A and the first sealing portion 21B. In the present embodiment, the first sealing portion 21B is joined also to the edge portion 20c at the another surface 20b of the metal plate 20A.

The first sealing portion 21C is joined to the one surface 20a (the outer surface) of the metal plate 20A. The overlapping region of the edge portion 20c at the one surface 20a of the metal plate 20A and the first sealing portion 21C is the joined region of the metal plate 20A and the first sealing portion 21C. The one surface 20a of the metal plate 20A has an exposed surface 20d that is exposed from the first sealing portion 21C. The conductive plate 5 is disposed so as to contact the exposed surface 20d.

In the present embodiment, the outer edge portions of the first sealing portions 21B, 21C that are embedded in the second sealing portion 22 are continuous. Namely, the first sealing portions 21B, 21C are formed by a single film being folded-over in two so as to nip the edge portion 20c of the metal plate 20A therebetween. The outer edge portions of the first sealing portions 21B, 21C are the folded-over portion of the film. The film that structures the first sealing portions 21B, 21C is joined to the edge portion 20c at both the one surface 20a and the another surface 20b of the metal plate 20A.

The first sealing portion 21D is joined to the one surface 20a of the metal plate 20B. The inner side portion 21b of the first sealing portion 21D is positioned between the edge portion 15c of the metal plate 15 of the positive electrode final end electrode 19, and the edge portion 20c of the metal plate 20B, which are adjacent to one another in the stacking direction D. The overlapping region of the edge portion 20c at the one surface 20a of the metal plate 20B and the first sealing portion 21D is the joined region of the metal plate 20B and the first scaling portion 21D.

The first sealing portion 21E is disposed at the edge portion 20c at the another surface 20b (the outer surface) of the metal plate 20B. In the present embodiment, the first sealing portion 21E is not joined to the metal plate 20B. The another surface 20b of the metal plate 20B has the exposed surface 20d that is exposed from the first sealing portion 21E. The conductive plate 5 is disposed so as to contact the exposed surface 20d.

In the present embodiment, the outer edge portions of the first sealing portions 21D, 21E that are embedded in the second sealing portion 22 are continuous. Namely, the first sealing portions 21D, 21E are formed by a single film being folded-over in two so as to nip the edge portion 20c of the metal plate 20B therebetween. The outer edge portions of the first sealing portions 21D, 21E are the folded-over portion of the film. The film that structures the first sealing portions 21D, 21E is joined to the edge portion 20c at the one surface 20a of the metal plate 20B.

Plural internal spaces V are provided within the electrode stack 11. The respective internal spaces V are provided between the metal plates that are adjacent to one another. The internal space V is a space that, between metal plates that are adjacent to one another in the stacking direction D, are partitioned airtightly and liquid-tightly by those metal plates and the sealing body 12. For example, an electrolytic liquid (not illustrated) is accommodated in the internal spaces V. The electrolytic liquid contains a non-aqueous solvent and a supporting salt for example. Examples of the non-aqueous solvent are organic solvents such as carbonates, ethers, esters, nitriles, sulfones, lactones and the like. Examples of the supporting salt are lithium salts such as LiPF₆ and the like. The electrolytic liquid permeates into the separators 13, the positive electrodes 16 and the negative electrodes 17.

FIG. 3 is a cross-sectional view orthogonal to the stacking direction of the power storing module illustrated in FIG. 2. As illustrated in FIG. 3, injection ports P are provided in one of the short-side portions 12a of the sealing body 12. The injection ports P pass-through the sealing body 12 in the long-side direction thereof. The injection ports P communicate the internal spaces V and the external space. The positions, at which the injection ports P are provided in the one short-side portion 12a of the sealing body 12, differ in accordance with the position in the stacking direction D (see FIG. 2) of the corresponding internal space V. The injection ports P are provided so as to be offset, in the short-side direction of the scaling body 12, such that the adjacent injection ports P do not overlap one another in the stacking direction D (see FIG. 2). In the example of FIG. 3, the injection port P is provided at one end portion of the one short-side portion 12a of the sealing body 12.

The shape, as seen from the stacking direction, of the internal region sealed by the sealing body 12 (i.e., the shape of the boundary surface between the internal space V and the sealing body 12 illustrated in FIG. 3) is rectangular. Note that the shape of the internal region that is sealed by the sealing body 12 is not limited to rectangular, and may be a quadrangular shape, or may be a polygonal shape other than quadrangular, or the like. Further, the corners of the polygonal shape may be rounded.

In FIG. 3, at the internal region (the rectangular region) that is sealed by the sealing body 12, the injection port P is formed only in a region of a sealing body 120 which region faces one side of the rectangle. However, the injection ports P may be provided at plural places. For example, the internal region that is sealed by the sealing body 12 may be polygonal, and a total of two or more of the injection ports P may be formed in regions of the scaling body 120 which regions face two or more sides of this polygon.

The positive electrode 16 includes plural divisional regions 16a that are separated by grooves 16A, 16B above the one surface 15a of the metal plate 15. Given that the surface, which is at the internal space V side of the side at which the injection port P is formed in the scaling body 12, is injection port side surface 150P, the grooves 16A, 16B extend from the side of the injection port side surface 150P in the direction opposite the injection port side surface 150P (i.e., extend in the Y direction in FIG. 3). Accordingly, in FIG. 3, the grooves 16A, 16B extend along the long-side direction of the one surface 15a. The bottom surfaces of the grooves 16A, 16B are structured by the one surface 15a.

Note that the side, in which the injection port P is formed, of the sealing body 12 means the side in which the injection port P is formed when viewing from the stacking direction of the electrode stack 11.

The plural divisional regions 16a are disposed so as to be apart from one another in the short-side direction of the one surface 15a. In the present embodiment, the positive electrode 16 is divided by the five grooves 16A, 16B into the six divisional regions 16a. The plural divisional regions 16a are rectangles whose long-side directions are the long-side direction of the one surface 15a, and whose short-side directions are the short-side direction of the one surface 15a.

An uncoated region 150 at which the positive electrode 16 is not formed is provided at the periphery of the plural divisional regions 16a on the one surface 15a of the metal plate 15. The uncoated region 150 includes an uncoated region 150A provided at the region facing the injection port side surface 150P, an uncoated region 150B provided at the side opposite the uncoated region 150A with the plural divisional regions 16a located therebetween, and uncoated regions 150C that are the regions between the uncoated region 150A and the uncoated region 150B and provided at the outer sides of the plural divisional regions 16a. Note that the internal space V is formed by the grooves 16A, 16B and the uncoated region 150.

Although not illustrated, the negative electrode 17 as well includes plural divisional regions that are divided by grooves in the same way as the positive electrode 16. The grooves of the negative electrode 17 are provided so as to overlap the grooves 16A, 16B of the positive electrode 16 as seen from the stacking direction D (see FIG. 2). Further, an uncoated region is provided also at the periphery of the negative electrode 17 that is divided into the plural divisional regions.

At the time of injecting an electrolytic liquid into the internal space V, the voids, which are formed by the grooves of the positive electrode 16 and the grooves of the negative electrode 17 being combined, function as flow paths of the electrolytic liquid, in the same way as the voids between the uncoated region 150 of the one surface 15a and the uncoated region of the another surface 15b.

The plural grooves include the grooves 16A and the grooves 16B that have different widths. Width [d_{A}] of the grooves 16A is set to be a larger width than width [d_{B}] of the grooves 16B. FIG. 3 illustrates an aspect in which there is one of the grooves 16A and four of the grooves 16B, but the grooves are not limited to this, and there may be two or more of the grooves 16A that are wide. Note that the grooves 16B have the same shapes for example. Further, in a case in which, differently than in FIG. 3, there are plural large-width grooves 16A, the grooves 16A also may have the same shapes for example. In FIG. 3, the shapes of the grooves 16A, 16B (the shapes in the cross-section orthogonal to the direction (the Y direction in FIG. 3) in which the grooves 16A, 16B extend) are rectangular. Note that the shapes of the grooves 16A, 16B are not particularly limited, and may be square, rectangular, triangular, trapezoidal or the like. In FIG. 3, the shape in the direction in which the grooves 16A, 16B extend (the shape when the grooves 16A, 16B are viewed in a top view) is rectilinear. Note that the shape in the direction in which the grooves 16A, 16B extend also is not particularly limited, and may be, for example, wave-shaped, polyline-shaped, lattice-shaped or the like.

A conventional battery is described here. In conventional batteries, reducing the volume of an uncoated region, at which an active material layer is not formed on a collector, has been studied from the standpoint of improving the battery capacity. However, there are cases in which it is difficult for electrolytic liquid to permeate into the grooves that are provided between the plural active material layers in order to have the electrolytic liquid permeate. This is thought to be because, due to the volume of the uncoated regions becoming smaller, the paths along which the electrolytic liquid permeates become narrower, and the electrolytic liquid permeation amount per unit time decreases, and therefore, time is needed in order for the electrolytic liquid to pervade into the entire internal space.

In contrast, in the embodiment of the present disclosure, the grooves 16A and the grooves 16B that have different widths are provided, and the width [d_{A}] of the grooves 16A is set to be a larger width than the width [d_{B}] of the grooves 16B. Therefore, the electrolytic liquid initially permeates from the injection port P into, of the internal space, the uncoated region 150A, and thereafter, passes-through the grooves 16A that are wide, and is quickly supplied to the uncoated region 150B as well. Thereafter, the electrolytic liquid that has permeated into the uncoated region 150B permeates from the uncoated region 150B side as well into the grooves 16B that are narrow, and it is easy for the electrolytic liquid to pervade into the entire internal space V. As a result, in manufacturing the battery, the time required until completion of permeation of the electrolytic liquid into the entire electrode stack 11 is shortened. Further, the occurrence of the defect of the electrolytic liquid not pervading into the entire active material layer after the injecting of the electrolytic liquid is completed, also is suppressed.

Here, the position at which the wide groove 16A is formed is described. The groove 16A that is wide being provided at a position satisfying at least one of following conditions (A1) and (A2) is preferable from the standpoint of the case of the electrolytic liquid pervading into the entire internal space V at the time of injecting the electrolytic liquid.

(A1) Among the plural grooves 16A, 16B, the groove 16A is provided at the position closest to the injection port P.
(A2) The groove 16A is provided at the position that is nearest to a position that is equidistant from the groove, which is provided the furthest toward an end (e.g., the groove that is the furthest toward the left side in FIG. 3), and from the groove, which is provided at the end at the opposite side (e.g., the groove that is the furthest toward the right side in FIG. 3), in the direction in which the plural grooves 16A, 16B are lined-up.
In FIG. 3, the groove 16A is provided at a position satisfying condition (A2).

Note that, in a case in which there are plural grooves 16A that are wide, it is preferable that at least one of the grooves 16A satisfies at least one condition among above (A1) and (A2).

Ratio ([d_{B}]/[d_{A}]) of the width [d_{B}] of the groove 16B with respect to the width [d_{A}] of the groove 16A is preferably greater than or equal to 0.07 and less than or equal to 0.40, and more preferably greater than or equal to 0.10 and less than or equal to 0.30. By setting [d_{B}]/[d_{A}] to be greater than or equal to the above lower limit value, it is easy for the electrolytic liquid to pervade into the entire internal space V at the time when the electrolytic liquid is injected. Setting [d_{B}]/[d_{A}] to be less than or equal to the above upper limit value is preferable from the standpoint that it is easy to improve the battery capacity.

The width [d_{A}] of the groove 16A is preferably greater than or equal to 5.0 mm and less than or equal to 15.0 mm, and is more preferably greater than or equal to 7.0 mm and less than or equal to 10.0 mm. Due to the width [d_{A}] being greater than or equal to the above lower limit value, it is easy for the electrolytic liquid to pervade into the entire internal space V at the time when the electrolytic liquid is injected. The width [d_{A}] being less than or equal to the above upper limit value is preferable from the standpoint that it is easy to improve the battery capacity.

The width [d_{B}] of the groove 16B is preferably greater than or equal to 0.5 mm and less than or equal to 4.0 mm, and is more preferably greater than or equal to 1.0 mm and less than or equal to 3.0 mm. Due to the width [d_{B}] being greater than or equal to the above lower limit value, it is easy for the electrolytic liquid to pervade into the entire internal space V at the time when the electrolytic liquid is injected. The width [d_{B}] being less than or equal to the above upper limit value is preferable from the standpoint that it is easy to improve the battery capacity.

The width [d_{A}] of the groove 16A and the width [d_{B}] of the groove 16B mean the dimension of the groove in the direction orthogonal to the direction in which each groove extends. In measuring the width at the groove, the dimension (the length) of the groove in the direction orthogonal to the direction in which the groove extends, when the groove is seen in a top view, is measured at five arbitrary places, and the arithmetic mean thereof is calculated.

The above embodiment describes an aspect in which there are grooves in the active material layers of both the positive electrode 16 and the negative electrode 17. However, the present disclosure is not limited to this, and grooves may be provided in only the positive electrode active material layer or in only the negative electrode active material layer. Note that, from the standpoint of suppressing precipitation of lithium, it is preferable for the grooves to be formed in only the positive electrode active material layer.

The dimensions of the electrode stack at the battery relating to the embodiment of the present disclosure are not particularly limited, but the surface area of the electrode stack when viewed from the stacking direction of the electrode stack can be made to be greater than or equal to 0.5 m² for example. The upper limit of the surface area of the electrode stack can be made to be less than or equal to 4.0 m².

Note that the structure of the present disclosure is not limited to the above-described embodiment, and the structure can be changed appropriately provided that the object of the disclosure can be achieved.

Next, effects of the battery relating to the embodiment of the present disclosure were confirmed by a simulation experiment.

### Example 1, Comparative Example 1

A simulation (CEA) was carried out on an electrode stack that had the structure illustrated in FIG. 3 and an active material layer on one surface of a metal plate serving as a collector, and in which the active material layer had divisional regions divided by grooves, and the electrode stack had, at the periphery of the active material layer, an uncoated region at which the active material layer was not provided. The cross-sectional shapes of the grooves and the uncoated region were rectangular. There were a total of 14 grooves, and the central two grooves were “grooves A”, and the remaining 12 grooves (six grooves at one side and six grooves at the other side of the two grooves A) were “grooves B”.

Table 1 shows the “widths” of the grooves A and the grooves B at the internal region sealed by the sealing body at uncoated region A (the uncoated region 150A in FIG. 3) provided at the region facing the side, in which the injection port was formed, of the sealing body, uncoated region B (the uncoated region 150B in FIG. 3) provided at the side opposite the uncoated region A with the divisional regions of the active material layer located therebetween, and uncoated regions C (the uncoated regions 150C in FIG. 3) provided at the region between the uncoated region A and the uncoated region B at the outer sides of the divisional regions of the active material layer.

In the simulation experiment, the time (permeation time) needed for completion of permeation of the electrolytic liquid into the entire electrode stack was calculated. The results are shown in Table 1.

TABLE 1

| | | | uncoated | uncoated | uncoated | |
|---|---|---|---|---|---|---|
| | grooves A | grooves B | region A | region B | region C | results: |
| | width mm | width mm | width mm | width mm | width mm | permeation time |
| Ex. 1 | 8 | 2 | 7 | 1 | 1 | 5 hours and 30 minutes |
| Comp. Ex. 1 | 2 | | | | | 6 hours and 55 minutes |

As illustrated in Table 1, it can be understood that, in Example 1 that satisfied the condition that the width of the grooves A was greater than the width of the grooves B, the time needed until completion of permeation of the electrolytic liquid into the entire electrode stack is shorter than in Comparative Example 1 that did not satisfy this condition. For this reason, it can be understood that a battery of an improved ability of an electrolytic liquid to permeate into an active material layer, was obtained in Example 1.

### EXPLANATION OF REFERENCE NUMERALS

1 bipolar power storage device, 11 electrode stack, 12 sealing body, 13 separator, 14 bipolar electrode, 15 metal plate (collector), 15a one surface, 15b another surface, 16 positive electrode, 17 negative electrode, D stacking direction, P injection port, V internal space

What is claimed is:

1. A battery comprising:
an electrode stack formed by stacking of electrodes that include collectors and active material layers, which are provided on one or both surfaces of the collectors and between which a plurality of grooves are provided and which are divided into a plurality of regions;
a sealing body that forms, between the collectors that are adjacent to one another, internal spaces in which an electrolytic liquid is accommodated, and that seals the internal spaces; and
injection ports formed in the sealing body and communicating the internal spaces and an exterior,
wherein
the internal spaces are formed by the grooves and by, at peripheries of the active material layers, uncoated regions at which the active material layers are not provided,
an internal region sealed by the sealing body is a polygonal shape when viewed from a stacking direction of the electrode stack, and
given that a surface of the sealing body, which surface is at the internal space side and is at a side in which the injection ports are formed, is an injection port side surface,
the grooves extend from a side of the injection port side surface in a direction opposite the injection port side surface, between the active material layers, and
at least a groove A and a groove B that have different widths are provided as the plurality of grooves, and a width of the groove A is wider than a width of the groove B.

2. The battery of claim 1, wherein
the internal region sealed by the sealing body is a quadrangular shape when viewed from the stacking direction of the electrode stack, and
the injection ports are provided in the sealing body only at a region facing one side of the quadrangular shape.

3. The battery of claim 1, wherein at least one of the grooves A satisfies at least one condition among following (A1) and (A2):
(A1) among the plurality of grooves, the groove A is provided at a position closest to the injection port; and
(A2) the groove A is provided at a position nearest to a position that is equidistant from a groove, which is provided furthest toward an end, and from a groove, which is provided at an end at an opposite side, in a direction in which the plurality of grooves are lined-up.

4. The battery of claim 1, wherein ratio ([d_{B}]/[d_{A}]) of width [d_{B}] of the groove B with respect to width [d_{A}] of the groove A is greater than or equal to 0.07 and less than or equal to 0.40.

5. The battery of claim 1, wherein width [d_{B}] of the groove B is greater than or equal to 0.5 mm and less than or equal to 4.0 mm.
